(19) United States
(12) Patent Application Publication
(10) Pub. No.: US 2015/0226937 A1
(43) Pub. Date: Aug. 13, 2015

(54) LENS UNIT STRUCTURE FOR MOLDED LENS AND MOLDING DIE FOR MOLDED LENS

(71) Applicant: OLYMPUS CORPORATION, Tokyo (JP)

(72) Inventors: Masaki OTSUKA, Hino-shi (JP); Koki IWASAWA, Akiruno-shi (JP); Yoshitaka OTSUKA, Hino-shi (JP); Hiroyuki SEKI, Hachioji-shi (JP)

(73) Assignee: OLYMPUS CORPORATION, Tokyo (JP)

(21) Appl. No.: 14/693,612

(22) Filed: Apr. 22, 2015

Related U.S. Application Data
(63) Continuation of application No. PCT/JP2014/052509, filed on Feb. 4, 2014.

(30) Foreign Application Priority Data
Apr. 4, 2013 (JP) 2013-078628

(51) Int. Cl. G02B 13/00; B29C 43/36

(52) U.S. Cl. CPC G02B 13/003; B29C 43/361; B29D 11/00413

(57) ABSTRACT

A first lens surface includes a first optically effective surface, and a convexly first engagement portion which protrudes toward a second lens side from an optical extended surface formed with the same curvature as the first optically effective surface as a position substantially corresponding to an outer edge of the first optically effective surface. A second lens surface includes a second optically effective surface larger in diameter than the first optically effective surface, and a convexly second engagement portion, which is provided outside the second optically effective surface, which protrudes toward a first lens side, which is engaged with the first engagement portion, which positions the first lens and the second lens.

### CROSS-REFERENCE TO RELATED APPLICATIONS

This application is a Continuation application of PCT Application No. PCT/JP2014/052509, filed Feb. 4, 2014 and based upon and claiming the benefit of priority from prior Japanese Patent Application No. 2013-078628, filed Apr. 4, 2013, the entire contents of all of which are incorporated herein by reference.

### BACKGROUND OF THE INVENTION

1. Field of the Invention

The present invention relates to a lens unit structure for a molded lens used in an imaging apparatus such as a digital camera or an endoscope, and a molding die for the molded lens.

2. Description of the Related Art

Recently, a camera used in, for example, a mobile telephone has two lenses adjacent in an optical axis direction. The lenses are axially symmetric with respect to the optical axis. Each of the lenses has a first protrusion portion provided in a flat portion formed on the outer side of an optical surface of the lens, and a second protrusion portion which is formed on the outer side of the optical surface of the lens and which is provided on a surface opposite to the optical surface. The first protrusion portion and the second protrusion portion are tapered along the optical axis direction, and have annular shapes. The first protrusion portion is provided inside the second protrusion portion. Thereby first protrusion portion of one of the lenses is engaged with the second protrusion portion of the other lens, one of the lenses overlap and is engaged with the other lens in the optical axis direction. A lens unit is assembled in this manner. The lens unit is then bonded to a body tube so that the optical axes of the two lenses (the first lens and the second lens) adjacent in the optical axis direction may correspond to each other and the first lens and the second lens may overlap each other in the optical axis direction.

The above-described structure is used in, for example, Japanese Patent No. 4362737. Japanese Patent No. 4362737 discloses a lens layout structure used in a mobile telephone. In this structure, protrusion portions having desired shapes are provided on the outer side of an optical surface of the lens, and the protrusion portions are engaged with each other. As a result, a contact adjust surface between the lens and the body tube holding the lens is reduced, and the reduction of costs for lens production and the assembly of the lens unit is suggested.

In the lens layout structure according to Japanese Patent No. 4362737, the first protrusion portion is engaged with the second protrusion portion, and the two lenses are thereby positioned in a direction that crosses the optical axis at right angles.

### BRIEF SUMMARY OF THE INVENTION

An aspect of a lens unit structure for a molded lens of the present includes at least two lenses disposed to face each other and is held while the one first lens and the other second lens that are disposed to face each other overlap, the first lens including a first lens surface facing the second lens, the first lens surface including a first optically effective surface, and a convexly first engagement portion which protrudes toward the second lens side from an optical extended surface formed with the same curvature as the first optically effective surface as a position substantially corresponding to an outer edge of the first optically effective surface, the second lens including a second lens surface facing the first lens surface, the second lens surface including a second optically effective surface larger in diameter than the first optically effective surface, and a convexly second engagement portion, the second engagement portion being provided outside the second optically effective surface, the second engagement portion protruding toward the first lens side, the second engagement portion being engaged with the first engagement portion, the second engagement portion positioning the first lens and the second lens relative to each other.

An aspect of a molding die for a molded lens molds one of the two lenses of the lens unit structure, wherein in a bush to mold the lenses, a molding surface to produce the optically effective surfaces and a step processing portion or a groove processing portion to produce protrusion portions of the engagement portions are processed in the same component.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of a lens unit structure for a molded lens according to a first embodiment of the present invention;

FIG. 2 is a sectional view taken along the line 2-2 shown in FIG. 1;

FIG. 3 is a longitudinal sectional view showing the configuration of essential parts in the lens unit structure for the molded lens according to the first embodiment;

FIG. 4 is an explanatory view illustrating an assembling method of a lens unit of the lens unit structure for the molded lens according to the first embodiment;

FIG. 5 is a plan view showing a fixed die of a molding die for the molded lens according to the first embodiment;

FIG. 6 is a longitudinal sectional view showing the molding die for the molded lens according to the first embodiment in a closed state;

FIG. 7 is a longitudinal sectional view showing the molding die for the molded lens according to the first embodiment in an opened state;

FIG. 8A is a diagram showing a bush of the fixed die according to the first embodiment, and is a plan view showing a molding surface of an optically effective surface of the bush and a step processing portion to produce a protrusion portion of an engagement portion;

FIG. 8B is a sectional view taken along the line 8B-8B shown in FIG. 8A;

FIG. 9 is a longitudinal sectional view showing the configuration of essential parts in a lens unit structure for a molded lens according to a second embodiment of the present invention;

FIG. 10 is a longitudinal sectional view showing the configuration of essential parts in a lens unit structure for a molded lens according to a third embodiment of the present invention;

FIG. 11 is a front view showing a modification of the outer shape of a lens unit structure for a molded lens according to a fourth embodiment of the present invention; and

FIG. 12 is a longitudinal sectional view showing the configuration of essential parts in a lens unit structure for a molded lens according to a fifth embodiment of the present invention.

### DETAILED DESCRIPTION OF THE INVENTION

Embodiments of the present invention will be described below in detail with reference to the drawings.

### First Embodiment

### Configuration

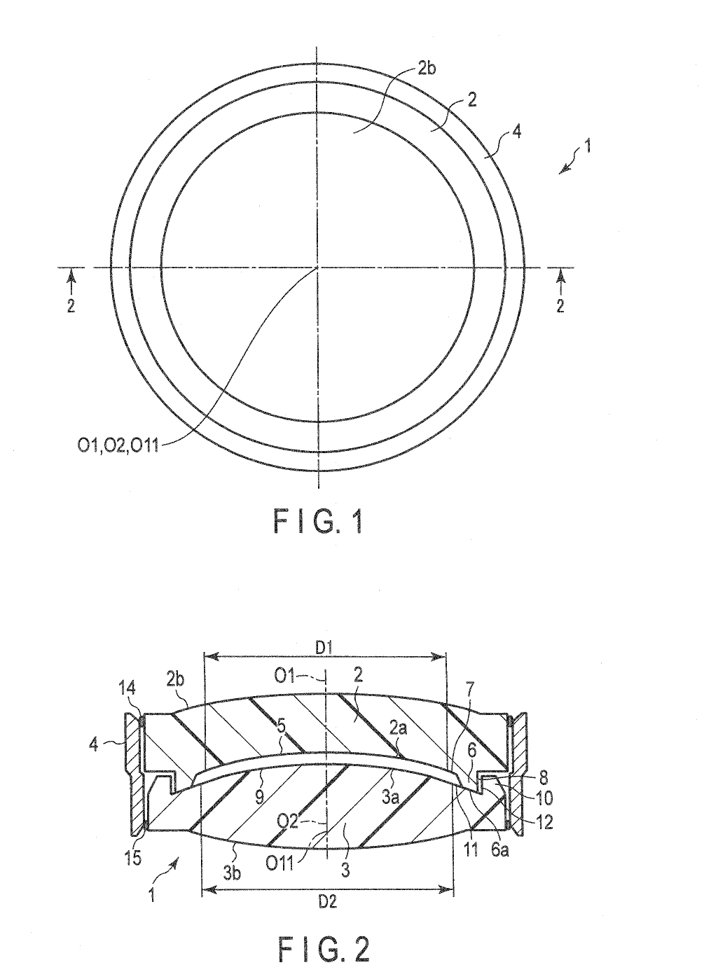

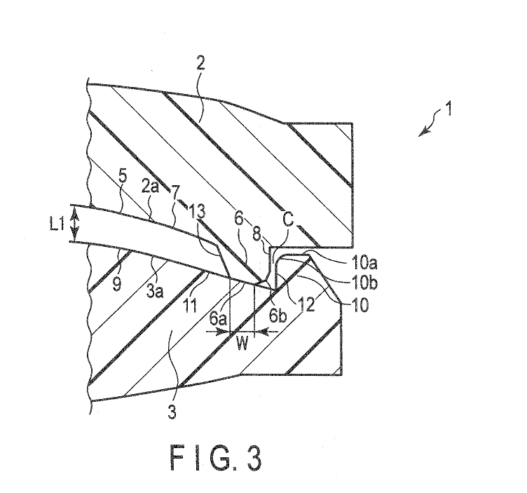

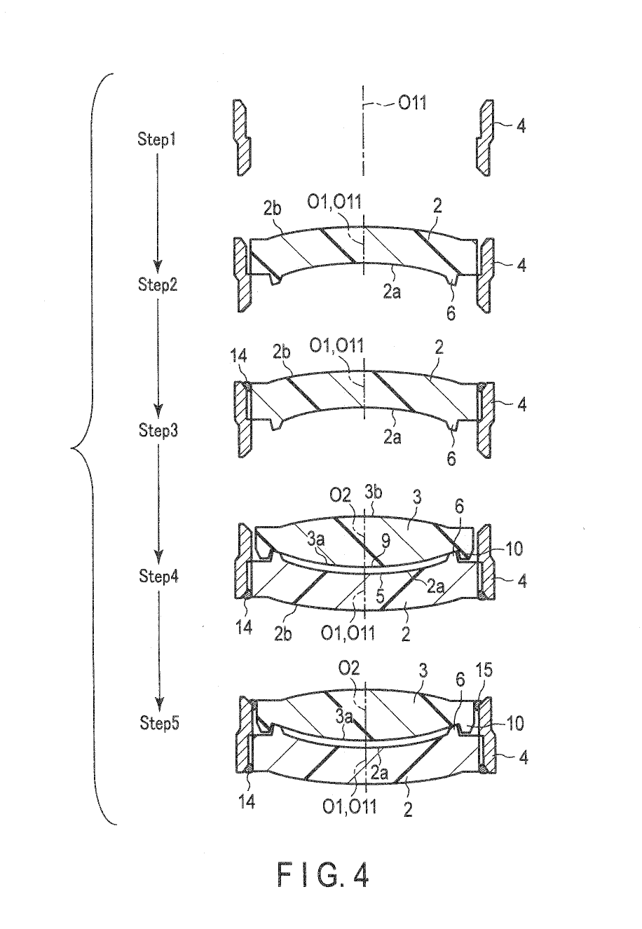

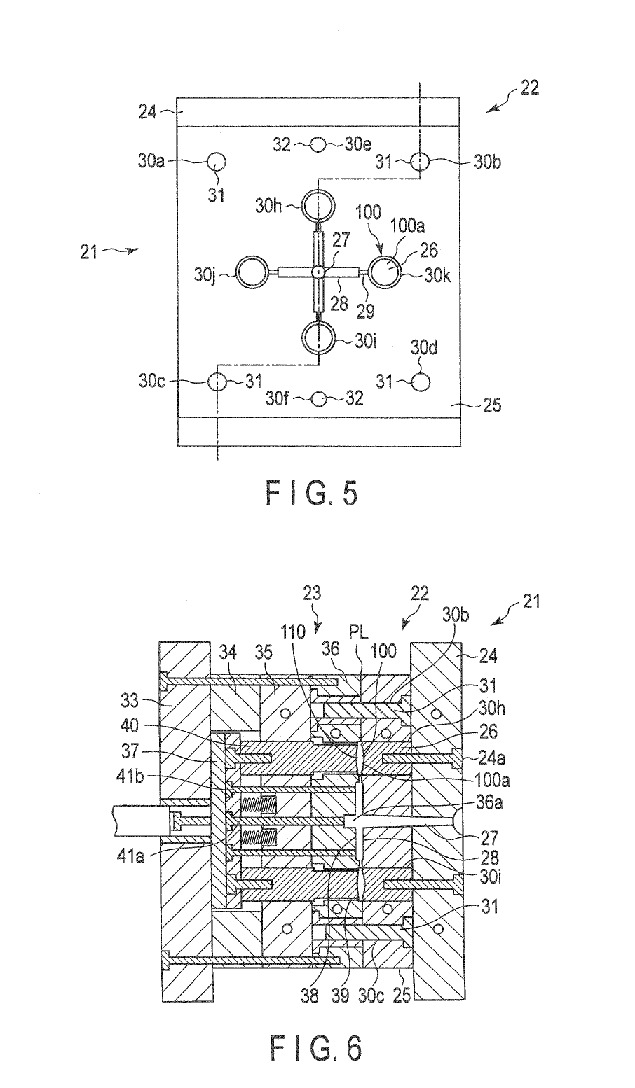

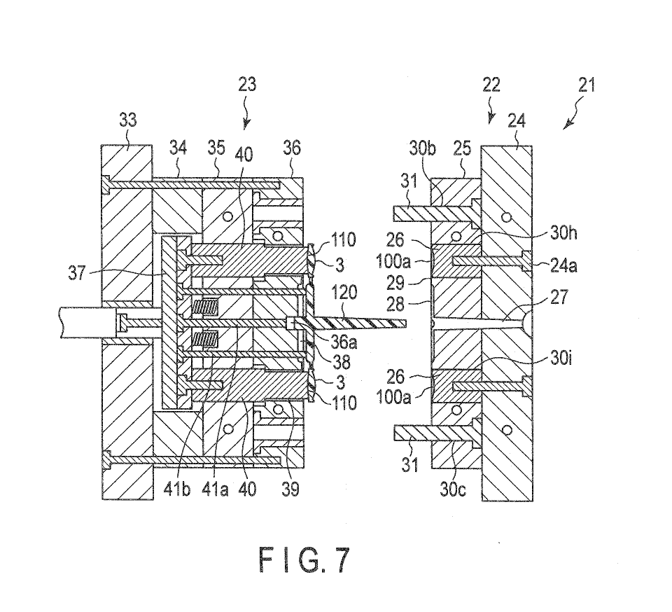

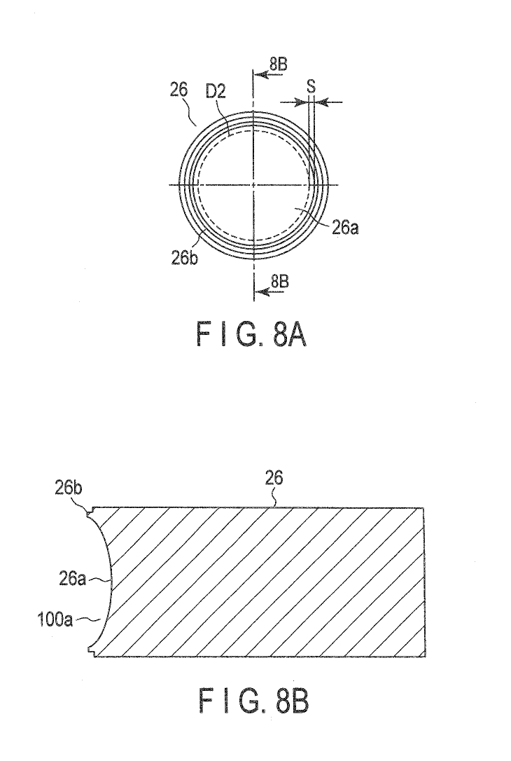

The first embodiment is described with reference to FIG. 1, FIG. 2, FIG. 3, FIG. 4, FIG. 5, FIG. 6, FIG. 7, FIG. 8A, and FIG. 83. In some of the drawings, some components are not shown for clarity of diagrammatic representation. Hereinafter, a straight line passing through the center of a first optically effective surface 5 in a first lens 2 is referred to as an optical axis O1 of the first lens 2. A straight line passing through the center of a second optically effective surface 9 in a second lens 3 is referred to as an optical axis O2 of the second lens 3. The center line of a body tube 4 is referred to as a central axis O11. The optical axis O1 is provided on the central axis of the first lens 2, and the optical axis O2 is provided on the central axis of the second lens 3. The optical axes O1 and O2 and the central axis O11 are provided on the central axis of a lens unit 1.

[Lens Unit 1 for Molded Lens]

A lens unit structure (hereinafter referred to as the lens unit 1) for a molded lens shown in FIG. 1 and FIG. 2 is used in, for example, an imaging apparatus such as a digital camera or an endoscope. The lens unit 1 has at least two lenses disposed to face each other, and the body tube 4 which holds the lenses.

The lenses include the first lens 2 and the second lens 3 that are molded with, for example, plastic. The body tube 4 holds the lenses so that the first lens 2 is adjacent to the second lens 3 in the central axis direction of the lens unit 1 and so that the optical axis O1 is provided coaxially with the optical axis O2. Thus, the first lens 2 and the second lens 3 disposed to face each other are held by the body tube 4 while the first lens 2 and the second lens 3 overlap each other in the optical axis direction of the lens unit 1.

The lenses including the first lens 2 and the second lens 3 are molded using an optically transmittable transparent resin material. This material has, for example, polycarbonate (PC). Thus, the lenses are formed as molded lenses. The body tube 4 functions as a frame body such that the first lens 2 and the second lens 3 are provided in the body tube 4.

[First Lens 2 and Second Lens 3]

As shown in FIG. 2, the first lens 2 is axially symmetric with respect to the optical axis O1. The second lens 3 is axially symmetric with respect to the optical axis O2.

As shown in FIG. 2, the first lens 2 has a first lens surface 2a facing the second lens 3, and a lens surface 2b provided opposite to the first lens surface 2a. The first lens surface 2a functions as an optical surface, and is a concavely curved surface. The lens surface 2b functions as an optical surface, and is a convexly curved surface. This first lens 2 is a concave lens (concave meniscus lens).

As shown in FIG. 2, the second lens 3 has a second lens surface 3a facing the first lens surface 2a of the first lens 2, and a lens surface 3b provided opposite to the second lens surface 3a. The second lens surface 3a functions as an optical surface, and is a convexly curved surface. The lens surface 3b functions as an optical surface, and is a convexly curved surface. This second lens 3 is a convex lens.

[First Lens Surface 2a]

As shown in FIG. 2, the first lens surface 2a has the first optically effective surface 5, and, for example, a ring-shaped first protrusion portion 6 protruding toward the second lens 3 side from a position substantially corresponding to the outer edge of the first optically effective surface 5 in the optical axis O1 direction. The first optically effective surface 5 has an effective diameter D1 used in, for example, imaging in the whole first lens surface 2a. The first lens surface 2a further has an optical extended surface 7 which is formed outside the effective diameter D1 of the first optically effective surface 5 and which is further formed with the same curvature as the first optically effective surface 5. The first protrusion portion 6 is formed at the end position of this optical extended surface 7. The end position is a position substantially corresponding to the outer edge of the first optically effective surface 5. The optical extended surface 7 is provided between the first optically effective surface 5 and the first protrusion portion 6 in the planar direction of the first lens surface 2a.

As shown in FIG. 2 and FIG. 3, the first protrusion portion 6 is provided to protrude along the optical axis O1 direction. A first engagement portion 8 is formed by the outer circumferential surface of the first protrusion portion 6. Here, the end position of this optical extended surface 7 is set, for example, 0.2 mm outside the effective diameter D1 in a diametrical direction of the first lens 2. The end position is included in the first lens surface 2a, the first optically effective surface 5, and the optical extended surface 7. With this end position as an origin (critical point), the first protrusion portion 6 is provided along the optical axis O1 direction.

[Second Lens Surface 3a]

As shown in FIG. 2, the second lens surface 3a has the second optically effective surface 9 larger in diameter than the first optically effective surface 5, and, for example, a ring-shaped second protrusion portion 10 which is provided outside the second optically effective surface 9 in a diametrical direction of the second lens surface 3a and which further protrudes toward the first lens 2 side.

The second lens surface 3a further has an optical extended surface 11 formed outside an effective diameter D2 of the second optically effective surface 9. The second protrusion portion 10 is formed at the end position of this optical extended surface 11. The end position is included in the second lens surface 3a, the second optically effective surface 9, and the optical extended surface 11. The optical extended surface 11 is provided between the second optically effective surface 9 and the second protrusion portion 10 in the planar direction of the second lens surface 3a.

As shown in FIG. 2 and FIG. 3, with the end position as an origin, the second protrusion portion 10 is provided to protrude along the optical axis O2 direction. A second engagement portion 12 which is engaged with the first engagement portion 8 and which positions the first lens 2 and the second lens 3 relative to each other is formed by the inner circumferential surface of the second protrusion portion 10. As shown in FIG. 3, the inner circumferential surface of the second protrusion portion 10 is disposed substantially parallel to the outer circumferential surface of the first protrusion portion 6. A clearance C is formed between the inner circumferential surface of the second protrusion portion 10 and the outer circumferential surface of the first protrusion portion 6. This clearance C is set with an allowable range of the displacement of the second lens 3 relative to the first lens 2 and the displacement of the first lens 2 relative to the second lens 3 in a diametrical direction of the lens unit 1. The allowable range is, for example, about 5 μm.

[Positioning]

As shown in FIG. 3, a distal face 6a of the first protrusion portion 6 abuts on the optical extended surface 11 with an abutment width W. As a result, an optical surface space L1 is set between the first lens surface 2a and the second lens surface 3a in the optical axes O1 and O2 direction. In other words, the length of the part between the first lens surface 2a and the second lens surface 3a in the optical axes O1 and O2 direction is defined. When the first protrusion portion 6 abuts on the second lens surface 3a, the first lens 2 and the second lens 3 are positioned relative to each other in the central axis direction of the lens unit 1.

The first protrusion portion 6 has an R-shaped portion 6b provided at a corner portion of the distal face 6a facing the clearance C. The second protrusion portion 10 has an R-shaped portion 10b provided at an inner circumferential side corner portion of a distal face 10a. The R-shaped portions 6b and 10b are obtuse-angled. The first lens 2 and the second lens 3 overlap over each other and loosely fitted before bonded to the body tube 4. In this instance, one of the first lens 2 and the second lens 3 can be pressed against and fitted into the other with a slight force so that the optical axis O1 and the optical axis O2 may be provided substantially coaxially and the distal face 6a may abut on the optical extended surface 11 owing to the R-shaped portion 6b and the R-shaped portion 10b. In this situation, if the distal face 6a abuts on the optical extended surface 11, the first lens 2 and the second lens 3 are positioned in the optical axes O1 and O2 direction and in a crosswise direction (the diametrical direction of the lens unit 1) that crosses the optical axes O1 and O2 direction at right angles, and the inclination of the first lens 2 relative to the second lens 3 and the inclination of the second lens 3 relative to the first lens 2 are adjusted to desired states. When the first protrusion portion 6 is engaged with the second protrusion portion 10 via the clearance C, the first lens 2 and the second lens 3 are positioned relative to each other, for example, in the diametrical direction of the lens unit 1.

The inner circumferential surface of the first protrusion portion 6 is formed as an inclined surface 13 which is inclined to gradually increase in diameter from the first optically effective surface 5 side toward the distal face 6a side (the second lens 3 side). The inclined surface 13 prevents the first protrusion portion 6 from overlapping the first optically effective surface 5 and the second optically effective surface 9. The outer circumferential surface of the first protrusion portion 6 is provided, for example, along the optical axis O1 direction. The inner circumferential surface of the second protrusion portion 10 is provided, for example, along the optical axis O2 direction.

[Assembling Method of Lens Unit 1 for Molded Lens]

An assembling method of the lens unit 1 for the molded lens is described with reference to FIG. 4.

As Step 1, a step of centering the central axis O11 of the body tube 4 and an unshown eccentric governor is performed.

As Step 2, the first lens 2 is then inserted into the body tube 4 so that the central axis O11 of the body tube 4 and the optical axis O1 may be coaxially provided each other.

As Step 3, an adhesive agent 14 is applied to the part between the outer circumferential surface of the first lens 2 and the body tube 4 so that the state in Step 2 will be maintained. When the adhesive agent 14 is cured, the body tube 4 holds the first lens 2 positioned.

As Step 4, the body tube 4 is turned upside down. The second lens 3 is then dropped into the body tube 4 from above the first lens 2 so that the first lens 2 may be adjacent to the second lens 3 in the central axis direction of the lens unit 1, the first lens 2 may overlap the second lens 3 in the optical axis direction of the lens unit 1, the first lens 2 may face the second lens 3 in the optical axis direction of the lens unit 1, the first lens surface 2a may face the second lens surface 3a in the optical axis direction of the lens unit 1, and the optical axis O1 may be provided coaxially with the optical axis O2. In this situation, the second lens 3 is then pressed against the first lens 2 and fitted into the first lens 2 with a slight force.

At the same time, the first protrusion portion 6 and the second protrusion portion 10 are engaged with each other, and the first lens 2 and the second lens 3 are thereby positioned relative to each other.

Finally, as Step 5, an adhesive agent 15 is applied to the part between the outer circumferential surface of the second lens 3 and the body tube 4 so that the state in Step 4 will be maintained. When the adhesive agent 15 is cured, the body tube 4 holds the second lens 3 positioned.

[Molding Die 21 for Molded Lens]

Now, the molding die 21 for the molded lens is described with reference to FIG. 5, FIG. 6, and FIG. 7. The configuration of the molding die for the first lens 2 is mostly the same as the configuration of the molding die for the second lens 3. Therefore, the molding die 21 for the second lens 3 is described, and the molding die for the first lens 2 is not described.

FIG. 5 is a plan view showing a fixed die 22 of the molding die 21. FIG. 6 is a longitudinal sectional view showing the molding die 21 in a closed state. FIG. 7 is a longitudinal sectional view showing the molding die 21 in an opened state. The molding die 21 has the fixed die 22 and a movable die 23. The fixed die 22 and the movable die 23 are mounted to a platen of an unshown injection molder. The fixed die 22 and the movable die 23 are disposed to face each other across a parting line (PL). The movable die 23 is supported so that the movable die 23 may be movable relative to the fixed die 22 in the open-close direction (lateral direction in FIG. 6).

When the fixed die 22 and the movable die 23 are combined into the closed state shown in FIG. 6, four cavities 100 which define the shape of the second lens 3 as a molded article are formed as shown in FIG. 5.

The fixed die 22 shown in FIG. 6 has a fixing side mounting plate 24, a fixing side die plate 25, and a fixing side bush 26. The fixing side die plate 25 is fixed to the fixing side mounting plate 24 while the fixing side die plate 25 overlaps the fixing side mounting plate 24. The fixing side bush 26 is a substantially shaft-shaped member. The fixing side bush 26 has a first transfer portion of fixing side cavities 100a in the shape of a concavely curved surface to transfer the second lens surface 3a to a resin 120 which is a molding material for the second lens 3. The first transfer portion is formed at a distal end of the fixing side bush 26.

FIG. 8A and FIG. 8B show the fixing side bush 26 for processing the molded lens. FIG. 8A is a plan view showing a molding surface 26a to produce the second optically effective surface 9 and a step processing portion 26b to produce the second protrusion portion 10. In the fixing side bush 26 shown in FIG. 8B, the molding surface 26a and the step processing portion 26b are integrally processed in the same component. The step processing portion 26b is processed at a position, for example, 0.2 mm or more outwardly apart from the molding surface 26a in a diametrical direction of the fixing side bush 26. Thus, the position of the inner circumferential surface of the second protrusion portion 10 is set on the optical extended surface 11 0.2 mm (see “S” indicated in FIG. 8A) or more outward from the effective diameter D2 of the second lens surface 3a in a diametrical direction of the second lens 3. The fixing side bush 26 has the step processing portion 26b here, but does not need to be limited to this. The fixing side bush 26 may have a groove processing portion to produce the second protrusion portion 10. The groove processing portion is processed at a position, for example, 0.2 mm or more outwardly apart from the molding surface 26a in the diametrical direction of the fixing side bush 26. In the fixing side bush 26, the molding surface 26a and the groove processing portion are integrally processed in the same component.

The fixed die 22 has a circular-hole-shaped sprue 27 functioning as a flow channel for supplying the resin 120 which is the molding material for the second lens 3 to the central position in FIG. 5. The sprue 27 passes through the fixing side mounting plate 24 and the fixing side die plate 25. The fixing side die plate 25 has four fixing side cavities 100a which are provided on a surface facing the movable die 23 and which are provided at an equal distance from the sprue 27. The fixing side die plate 25 also has a runner groove 28 and a gate groove 29 that are formed between the four fixing side cavities 100a and the sprue 27.

In the present embodiment, one sprue 27 and four fixing side cavities 100a are provided, the four fixing side cavities 100a and the sprue 27 are coupled by the runner groove 28 and the gate groove 29, and the number of molded articles to be obtained is four. However, the number does not need to be limited to this. The number of molded articles to be obtained may be more than one instead of four, or may be one.

The fixing side die plate 25 also has four fixing side guide pin insertion hole portions 30a, 30b, 30c, and 30d, and two fixing side positioning pin insertion hole portions 30e and 30f. Fixing side guide pins 31 are inserted through the four fixing side guide pin insertion hole portions 30a, 30b, 30c, and 30d, respectively. Fixing side positioning pins 32 are inserted through the fixing side positioning pin insertion hole portions 30e and 30f, respectively.

Furthermore, the fixing side die plate 25 has fixing side bush insertion hole portions 30h, 30i, 30j, and 30k in central portions of parts corresponding to the four fixing side cavities 100a, respectively. The fixing side bushes 26 are inserted through the fixing side bush insertion hole portions 30h, 30i, 30j, and 30k, respectively. The fixing side bushes 26 and the fixing side positioning pins 32 are fixed to the fixing side mounting plate 24 by fixing screws 24a.

The fixing side die plate 25 also has a second transfer portion to transfer the side surface part of the second lens 3 except for the second lens surface 3a to the resin 120 which is the molding material for the second lens 3. The second transfer portion is provided in the four fixing side cavities 100a. The fixing side cavity 100a according to the present embodiment has the first transfer portion of the fixing side bush 26 and the second transfer portion of the fixing side die plate 25.

The movable die 23 has a movable side mounting plate 33, a spacer block 34, a movable side backing plate 35, and a movable side die plate 36. The spacer block 34 has an ejector plate 37 provided therein. The ejector plate 37 functions as an ejection mechanism to eject the second lens 3 which is a molded article. The ejector plate 37 can be in and out of contact with the movable side mounting plate 33. The spacer block 34 and the movable side backing plate 35 are fixed on the movable side mounting plate 33 while the spacer block 34 and the movable side backing plate 35 overlaps the movable side mounting plate 33.

The movable die 23 also has a circular recess portion 36a which is formed in the movable side die plate 36 and which corresponds to the sprue 27. The movable side die plate 36 further has four movable side cavities 110 provided on a surface facing the fixed die 22. The movable side cavities 110 are at an equal distance from the circular recess portion 36a. The movable side die plate 36 has a movable side runner groove 38 formed between the four movable side cavities 110 and the circular recess portion 36a.

The movable side die plate 36 also has movable side bush insertion hole portions 39 in central portions of part corresponding to the four movable side cavities 110, respectively. Movable side bushes 40 are inserted through the four movable side bush insertion hole portions 39, respectively. The movable side bush 40 is a substantially shaft-shaped member. Here, a clearance is formed between the movable side bush insertion hole 39 and the movable side bush 40, and the movable side bush insertion hole 39 and the movable side bush 40 are out of contact with each other.

The movable side bush 40 has a first transfer portion in the shape of a concavely curved surface to transfer the lens surface 3b to the resin 120 which is the molding material for the second lens 3. The first transfer portion is formed at a distal end of the movable side bush 40. The movable side die plate 36 also has a second transfer portion to transfer the side surface part of the second lens 3 except for the lens surface 3b to the resin 120. The second transfer portion is provided in the four movable side cavities 110. The movable side cavity 110 according to the present embodiment has the first transfer portion of the movable side bush 40 and the second transfer portion of the movable side die plate 36.

Ejector pins (a center pin 41a and four ejector pins 41b) are mounted to the ejector plate 37. Here, the center pin 41a is located at the central position of the ejector plate 37 and at the position corresponding to the circular recess portion 36a. Moreover, the four ejector pins 41b are located around the center pin 41a and at positions corresponding to the movable side runner groove 38. The ejector plate 37 moves in a direction (closing direction) opposite to the opening direction of the movable die 23 as shown in FIG. 7 after the molding of the second lens 3 which is a molded article (resin lens). In response to the movement of the ejector plate 37, the center pin 41a is ejected to the circular recess portion 36a, the four ejector pins 41b are ejected to the movable side runner groove 38, and the movable side bushes 40 are ejected to the movable side cavities 110. As a result, the resin 120 filling the flow channel is ejected, and the molded article (resin lens) to be provided in the movable die 23 is ejected.

[Functions]

In the lens unit 1 for the molded lens according to the present embodiment, the first protrusion portion 6 for positioning is formed at the end position of the optical extended surface 7, and the first protrusion portion 6 is provided along the optical axis O1 direction with the end position as an origin (critical point). When the distal face 6a of the first protrusion portion 6 abuts on the optical extended surface 11 with the abutment width W, the optical surface space L1 is set along the optical axes O1 and O2 direction between the first lens surface 2a of the first lens 2 and the second lens surface 3a of the second lens 3. That is, the length of the part between the first lens surface 2a and the second lens surface 3a in the optical axes O1 and O2 direction is defined.

### Advantageous Effects

Thus, in the present embodiment, the first protrusion portion 6 which is a positioning member to position the first lens 2 and the second lens 3 relative to each other is provided at the end position of the optical extended surface 7 which is a position substantially corresponding to the outer edge of the first optically effective surface 5. This is referred to as a first case. In the first case, the outside diameters of the first lens 2, the second lens 3, and the whole lens unit 1 can be smaller than in a second case in which the protrusion portion is provided in a flat surface provided outside the optical surface of the lens. In the first case, inflection points to produce the shape of the first protrusion portion 6 can be fewer in number than in the second case.

In the present embodiment, when the distal face 6a of the first protrusion portion 6 abuts on the optical extended surface 11 of the second lens 3 with the abutment width W, the optical surface space L1 is set between the first lens surface 2a of the first lens 2 and the second lens surface 3a of the second lens 3. Thus, the first lens 2 and the second lens 3 are positioned in the central axis direction of the lens unit 1. In contrast, heretofore, the optical surface space L1 has been determined when the lenses are pressed against each other under a set condition. This optical surface space L1 changes depending on the press force, and therefore requires positioning and adjustments at the time of assembly. In the present embodiment, the positioning and adjustments can be unnecessary. Moreover, in the present embodiment, the two lenses adjacent in the optical axis direction can be accurately positioned, and the whole lens unit 1 for the molded lens can be reduced in diameter and can be easily assembled.

In the present embodiment, the optical surface space L1 which is the distance between the first lens surface 2a and the second lens surface 3a can be set in accordance with the height of the first protrusion portion 6, and the first lens 2 and the second lens 3 can be positioned relative to each other in the central axis direction of the lens unit 1. The distal face 6a comes into surface abutment with the optical extended surface 11. Thus, when the second lens 3 is pressed against the first lens 2 during assembly, for example, as in Step 4 shown in FIG. 4, plastic deformation of the first protrusion portion 6 and breakdown of the first protrusion portion 6 caused by the press force can be prevented.

In the present embodiment, the R-shaped portions 6b and 10b are provided. Thus, during the assembling operation for the first lens 2 and the second lens 3 of the lens unit 1, one of the first lens 2 and the second lens 3 can be pressed against and fitted into the other with a slight force so that the optical axis O1 and the optical axis O2 may be provided substantially coaxially and the distal face 6a may abut on the optical extended surface 11 owing to the R-shaped portion 6b and the R-shaped portion 10b. Therefore, the first protrusion portion 6 and the second protrusion portion 10 can be easily loosely-fitted, and the assembling operation for the first lens 2 and the second lens 3 can be easily performed. The lens unit 1 can thus be easily assembled, thereby the lens unit 1 which is an optical component with a low assembly cost can be obtained.

If the distal face 6a abuts on the optical extended surface 11, the first lens 2 and the second lens 3 can be positioned relative to each other in the optical axes O1 and O2 direction and in the crosswise direction (the diametrical direction of the lens unit 1) that crosses the optical axes O1 and O2 direction at right angles, and the inclination of the first lens 2 relative to the second lens 3 and the inclination of the second lens 3 relative to the first lens 2 can be adjusted to desired states. The positioning and adjustments can be performed at the same time during the assembling operation for the first lens 2 and the second lens 3. If the first protrusion portion 6 is engaged with the second protrusion portion 10, the first lens 2 and the second lens 3 can be positioned relative to each other. As described above, plastic deformation and breakdown can be prevented. Therefore, the two lenses adjacent in the optical axis direction can be accurately positioned.

Furthermore, even if positioning members such as the first protrusion portion 6 and the second protrusion portion 10 are provided, the outside diameters of the first lens 2 and the second lens 3 do not considerably exceed the first optically effective surface 5 and the second optically effective surface 9. Even the first protrusion portion 6 and the second protrusion portion 10 are provided, the influence of the first protrusion portion 6 and the second protrusion portion 10 on the size of the body tube 4 is small.

The inner circumferential surface of the first protrusion portion 6 is formed as an inclined surface which increases in diameter. Thus, the distal face 6a of the first protrusion portion 6 can abut on the second lens surface 3a outside the second optically effective surface 9. It is therefore possible to prevent the second optically effective surface 9 from being reduced in size by the first protrusion portion 6.

For example, the molding die 21 used for the molding of the second lens 3 is provided in the fixing side bush 26, and has the molding surface 26a of the second optically effective surface 9, and the step processing portion 26b to produce the second protrusion portion 10. The molding surface 26a and the step processing portion 26b are integrally processed in the same component, thereby the second optically effective surface 9 and the second protrusion portion 10 can be integrally obtained, and the relative positions of the second optically effective surface 9 and the second protrusion portion 10 can be maintained. Thus, it is possible to obtain an accurate die. Owing to this die, the coaxiality of the optical axis O2 of the second lens 3 and the second protrusion portion 10 can be extremely low, and it is possible to prevent step process from affecting the processing accuracy of the optical surface.

In the fixing side bush 26, the step processing portion 26b is processed at the position 0.2 mm or more outwardly apart from the molding surface 26a. Thus, it is possible to secure a minimum required margin of 0.2 mm for the polishing of the optical surface of the die outside the optical surface.

### Second Embodiment

### Configuration

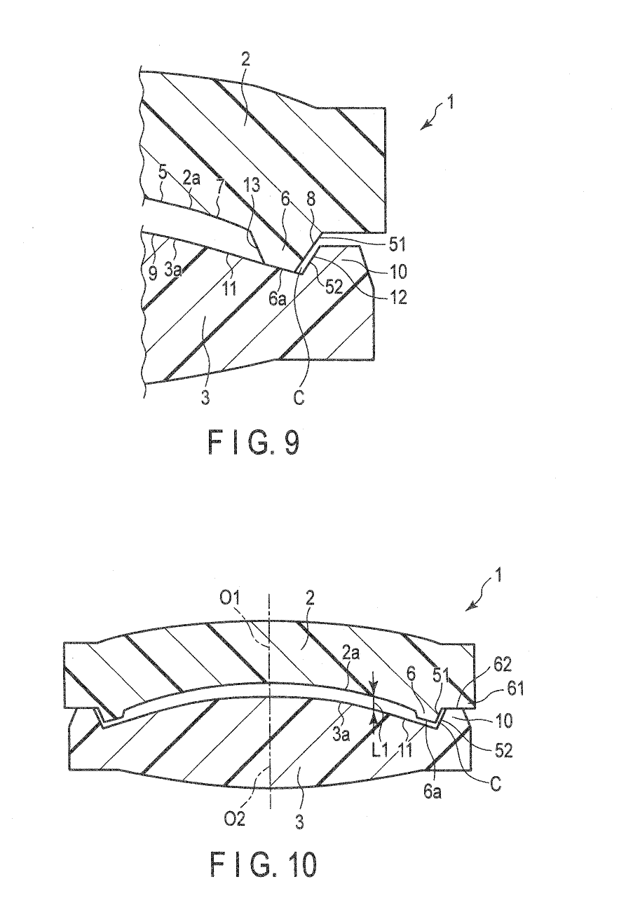

The second embodiment of the present invention is described with reference to FIG. 9. The differences between the second embodiment and the first embodiment are described below.

In the first lens 2 according to the present embodiment, the outer circumferential surface of the first protrusion portion 6 is formed as an inclined surface 51 which is inclined to gradually decrease in diameter toward the second lens 3 side. Moreover, in the second lens 3, the inner circumferential surface of the second protrusion portion 10 is formed as an inclined surface 52 which is inclined to gradually increase in diameter toward the first lens 2 side. A clearance C similar to that in the first embodiment is formed between the inclined surface 51 and the inclined surface 52.

### Advantageous Effects

In the present embodiment, the R-shaped portions 6b and 10b can be omitted, and positioning operation of the first lens 2 and the second lens 3 can be more easily performed.

### Third Embodiment

### Configuration

The third embodiment of the present invention is described with reference to FIG. 10. The differences between the third embodiment and the first and second embodiments are described below.

In the first lens 2 according to the present embodiment, the distal face 6a of the first protrusion portion 6 does not abut on the optical extended surface 11, and is out of abutment. The first lens 2 further has a planar outer end portion 61 which is formed outside the first protrusion portion 6 and which extends in the crosswise direction that crosses the optical axis O1 direction at right angles. The outer end portion 61 is included in the first lens surface 2a.

The second lens 3 has a planar portion 62 which is formed in the distal face of the second protrusion portion 10 and which abuts on the outer end portion 61. When the outer end portion 61 abuts on the planar portion 62, the optical surface space L1 is set. That is, the second protrusion portion 10 abuts on the outer end portion 61 in the first lens surface 2a, so that the first lens 2 and the second lens 3 are positioned relative to each other in the central axis direction of the lens unit 1.

In the present embodiment as well as in the second embodiment, the inclined surfaces 51 and 52 are provided, and the clearance C is formed.

### Advantageous Effects

In the present embodiment, the optical surface space L1 is set when the outer end portion 61 abuts on the planar portion 62. Thus, the first lens 2 and the second lens 3 can be easily positioned in the optical axis O1 direction.

Moreover, in the present embodiment, the optical surface space L1 which is the distance between the first lens surface 2a and the second lens surface 3a can be set in accordance with the height of the second protrusion portion 10, and the first lens 2 and the second lens 3 can be positioned in the central axis direction of the lens unit 1. The planar portion 62 abuts on the outer end portion 61 in a surface contact state. Thus, when the second lens 3 is pressed against the first lens 2, for example, during assembly, plastic deformation of the planar portion 62 and breakdown of the planar portion 62 caused by the press force can be prevented.

### Fourth Embodiment

### Configuration

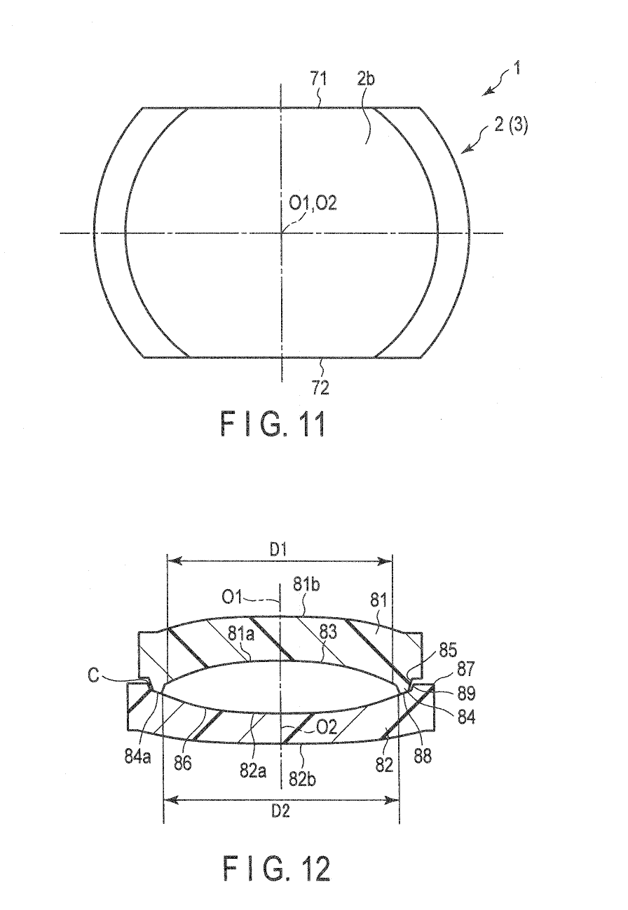

The fourth embodiment of the present invention is described with reference to FIG. 11. The differences between the fourth embodiment and the first, second, and third embodiments are described below. In the present embodiment, part of the outer shape of the first lens 2 is cut out along a crosswise direction that crosses the central axis of the first lens 2 at right angles. A cutout portion 71 is provided in one part of the first lens 2, a cutout portion 72 is provided in the other part of the first lens 2, and the cutout portions 71 and 72 are provided parallel to each other. The same also applies to the second lens 3.

### Advantageous Effects

The lens unit 1 according to the present embodiment also makes it possible to obtain the same advantageous effects as those obtained by the lens unit 1 according to the first embodiment.

### Fifth Embodiment

### Configuration

The fifth embodiment of the present invention is described with reference to FIG. 12. The differences between the fifth embodiment and the first, second, third, and fourth embodiments are described below.

A first lens 81 has a first lens surface 81a facing a second lens 82, and a lens surface 81b provided opposite to the first lens surface 81a. The first lens surface 81a functions as an optical surface, and is a concavely curved surface. The lens surface 81b functions as an optical surface, and is a convexly curved surface. This first lens 81 is a concave lens (concave meniscus lens).

The second lens 82 has a second lens surface 82a facing the first lens 81, and a lens surface 82b provided opposite to the second lens surface 82a. The second lens surface 82a functions as an optical surface, and is a convexly curved surface. The lens surface 82b functions as an optical surface, and is a convexly curved surface. This second lens 82 is a concave lens (concave meniscus lens).

The first lens surface 81a has a first optically effective surface 83, and, for example, a ring-shaped first protrusion portion 84 protruding toward the second lens 82 side from a position substantially corresponding to the outer edge of the first optically effective surface 83 in the central axis direction of the second lens 82. The first optically effective surface 83 has an effective diameter D1 used in, for example, imaging in the whole first lens surface 81a. The first protrusion portion 84 is formed outside the effective diameter D1 of the first optically effective surface 83. The first protrusion portion 84 is provided to protrude in a direction coaxial with an optical axis O1 of the first lens 81. A first engagement portion 85 is formed by the outer circumferential surface of the first protrusion portion 84.

The second lens surface 82a has a second optically effective surface 86 larger in diameter than the first optically effective surface 83, and, for example, a ring-shaped second protrusion portion 87 which is provided outside the second optically effective surface 86 in a diametrical direction of the second lens surface 82a and which further protrudes toward the first lens 81 side.

The second lens surface 82a further has an optical extended surface 88 formed outside an effective diameter D2 of the second lens surface 82a. The second protrusion portion 87 is formed at the end position of this optical extended surface 88. The optical extended surface 88 is provided between the second optically effective surface 86 and the second protrusion portion 87 in the planar direction of the second lens surface 82a.

With the end position as an origin, the second protrusion portion 87 is provided to protrude in the direction coaxial with the optical axis O1. A second engagement portion 89 which is engaged with the first engagement portion 85 and which positions the first lens 81 and the second lens 82 relative to each other is formed by the inner circumferential surface of the second protrusion portion 87. The inner circumferential surface of the second protrusion portion 87 is disposed substantially parallel to the outer circumferential surface of the first protrusion portion 84. A clearance C is formed between the inner circumferential surface of the second protrusion portion 87 and the outer circumferential surface of the first protrusion portion 84. This clearance C is set with an allowable range of the displacement of the second lens 82 relative to the first lens 81 and the displacement of the first lens 81 relative to the second lens 82 in the diametrical direction of the lens unit 1. The allowable range is, for example, about 5 μm.

A distal face 84a of the first protrusion portion 84 abuts on the optical extended surface 88. As a result, an optical surface space L1 is set between the first lens surface 81a and the second lens surface 82a along the optical axis O1 direction. That is, the length of the part between the first lens surface 81a and the second lens surface 82a in the optical axis O1 direction is defined.

### Advantageous Effects

The lens unit 1 according to the present embodiment also makes it possible to obtain the same advantageous effects as those obtained by the lens unit 1 according to the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A lens unit structure for a molded lens which comprises at least two lenses, disposed to face each other, and which is held while a first lens and a second lens that are disposed to face each other overlap,
the first lens comprising a first lens surface facing the second lens,
the first lens surface comprising a first optically effective surface, and a convexly first engagement portion which protrudes toward the second lens side from an optical extended surface formed with the same curvature as the first optically effective surface as a position substantially corresponding to an outer edge of the first optically effective surface,
the second lens comprising a second lens surface facing the first lens surface,
the second lens surface comprising a second optically effective surface larger in diameter than the first optically effective surface, and a convexly second engagement portion, the second engagement portion being provided outside the second optically effective surface, the second engagement portion protruding toward the first lens side, the second engagement portion being engaged with the first engagement portion, the second engagement portion positioning the first lens and the second lens relative to each other.

2. The lens unit structure for the molded lens according to claim 1, wherein:
when a distal face of the convexly first engagement portion abuts on the second lens surface, the first lens and the second lens are positioned relative to each other in a central axis direction of the lens unit structure, and
when an outer circumferential surface of the convexly first engagement portion is engaged with an inner circumferential surface of the second engagement portion, the first lens and the second lens are positioned relative to each other in a diametrical direction of the lens unit structure.

3. The lens unit structure for the molded lens according to claim 1, wherein:
when a distal face of the convexly second engagement portion abuts on the first lens surface, the first lens and the second lens are positioned relative to each other in a central axis direction of the lens unit structure, and
when an outer circumferential surface of the convexly first engagement portion is engaged with an inner circumferential surface of the second engagement portion, the first lens and the second lens are positioned relative to each other in a diametrical direction of the lens unit structure.

4. The lens unit structure for the molded lens according to claim 1, wherein an inner circumferential surface of the first engagement portion is formed as an inclined surface which is inclined to gradually increase in diameter toward the second lens side.

5. The lens unit structure for the molded lens according to claim 2, wherein when the outer circumferential surface of the convexly first engagement portion is engaged with the inner circumferential surface of the second engagement portion via a clearance, the first lens and the second lens are positioned relative to each other in the diametrical direction of the lens unit structure.

6. A molding die for a molded lens to mold one of the at least two lenses of the lens unit structure according to claim 1, wherein, in a bush to mold the lenses, a molding surface to produce the optically effective surfaces and a step processing portion or a groove processing portion to produce protrusion portions of the engagement portions are processed in a same component.

7. The molding die for the molded lens according to claim 6, wherein the groove processing portion is processed at a position 0.2 mm or more outwardly apart from the molding surface in a diametrical direction of the bush.

8. The lens unit structure for the molded lens according to claim 3, wherein when the outer circumferential surface of the convexly first engagement portion is engaged with the inner circumferential surface of the second engagement portion via a clearance, the first lens and the second lens are positioned relative to each other in the diametrical direction of the lens unit structure.
